(19) United States
(12) Patent Application Publication
(10) Pub. No.: US 2016/0178417 A1
(43) Pub. Date: Jun. 23, 2016

(54) method and apparatus for checking a pressure-based mass flow sensor in an air delivery system for an internal combustion engine

(71) Applicant: Robert Bosch GmbH, Stuttgart (DE)

(72) Inventors: Thomas BLEILE, Stuttgart-Zuffenhausen (DE); Daniel Kuhn, Walddorfhaeslach (DE)

(21) Appl. No.: 14/970,727

(22) Filed: Dec. 16, 2015

(30) Foreign Application Priority Data
Dec. 17, 2014 (DE) 10 2014 226 181.3

(51) Int. Cl. G01F 1/50

(52) U.S. Cl. CPC G01F 1/50

(57) ABSTRACT

A method for checking a functional capability of a pitot mass flow sensor for measuring a mass flow of an inflowing gas in an engine system having an internal combustion engine, includes: measuring, as partial measured variables, a dynamic pressure that corresponds to a pitot pressure of a pitot tube of the pitot mass flow sensor; an absolute pressure; and a temperature of the inflowing gas; determining a diagnostic value depending on the partial measured variables and on a mass flow in the internal combustion engine; and ascertaining a functional capability of the pitot mass flow sensor depending on whether the diagnostic value indicates that a mathematical relationship between the partial measured variables corresponds to a predefined relationship.

### BACKGROUND OF THE INVENTION

1. Field of the Invention

The present invention relates to internal combustion engines, and in particular to measures taken for sensing an air mass flow in an air delivery system for an internal combustion engine. The present invention relates in particular to measures for checking correct functioning of a pressure-based air mass sensor, in particular based on a pitot principle.

2. Description of the Related Art

In order to operate an internal combustion engine it is necessary to measure, as a state variable, an air mass flow in an internal combustion engine. In addition to conventional measurement using a hot film air mass sensor (HFM), a novel method makes provision for mass flow sensing with the aid of a pressure-based mass flow sensor, for example with a pitot mass flow sensor. A pitot mass flow sensor measures a dynamic pressure, the absolute pressure, and a temperature of the gas flowing past, with the aid of a pitot tube and further sensors. A mass flow of a gas stream flowing past may thereby be determined, either in the pitot mass flow sensor itself or later in an engine control unit.

It is usual to provide an additional sensor, in particular a pressure sensor, in order to plausibilize the functioning of the pitot mass flow sensor.

With the aid of a sensor variable of the additional sensor, a reference mass flow at the location of the pitot mass flow sensor can be directly sensed or modeled in a different manner, so as thereby to check the functioning of the pitot mass flow sensor by comparing the reference mass flow with the mass flow determined with the aid of the pitot mass flow sensor. Determination of the reference mass flow requires the presence of the additional sensor, and it is desirable to make available a plausibilization method that enables plausibilization of the pitot air mass sensor even without an additional pressure sensor.

### BRIEF SUMMARY OF THE INVENTION

According to a first aspect, a method is provided for checking a functional capability of a pitot mass flow sensor for measuring a mass flow of an inflowing gas in an engine system having an internal combustion engine, having the following steps:
measuring, as partial measured variables, a dynamic pressure that corresponds to a pitot pressure of a pitot tube of the pitot mass flow sensor, an absolute pressure, and a temperature of the inflowing gas;
determining a diagnostic value depending on the partial measured variables and on a mass flow in the internal combustion engine;
ascertaining a functional capability of the pitot mass flow sensor depending on the diagnostic value, in particular depending on whether the diagnostic value indicates that a mathematical relationship between the partial measured variables corresponds to a predefined relationship.

The above method for checking the functional capability of the pitot mass flow sensor is not based on a comparison between a mass flow measured therewith and a separately determined reference mass flow. What is used instead is the fact that the pitot mass flow sensor determines the mass flow from three partial measured variables, namely the dynamic pressure, an absolute pressure, and a temperature of the gas flowing past. These three partial measured variables are plausibilized against one another on the basis of a comparison of flow velocities or volumetric flows. The result, for a pitot mass flow sensor, is a capability for diagnosis that is based on the measured values of the three partial measured variables and requires only the engine speed and air consumption (air charge) as external variables. The result in particular, for a steady-state operating point, is a linear correlation of the partial measured variables, thereby enabling plausibilization.

The above method has the advantage that an additional pressure sensor in the air delivery system is not required for plausibilization or for checking the functional capability of the pitot mass flow sensor. If no further requirements exist regarding the provision of an additional pressure sensor, in particular in the region downstream from where the exhaust gas recirculation duct opens into an intake duct segment of the air delivery system, the pressure sensor there can be omitted and the existing pressure sensor of the pitot air mass sensor can be used instead. The possibility of omitting the pressure sensor in the intake duct segment of the air delivery system represents a considerable cost advantage, and it is nevertheless possible to check the functional capability of the pitot mass flow sensor reliably during operation of the internal combustion engine.

The diagnostic value can furthermore be determined by a comparison of the gas velocities or volumetric flows in the internal combustion engine.

Provision can be made that in an internal combustion engine having exhaust gas recirculation, the diagnostic value is determined with the exhaust gas recirculation valve closed.

The functional capability of the pitot mass flow sensor can in particular be ascertained if a release condition is met, the release condition encompassing in particular one or more of the following criteria:
the rotation speed of the internal combustion engine is within a predefined rotation speed range;
the injection volume or torque of the internal combustion engine is within a predefined range;
the throttle valve is open, in particular completely open;
the ambient temperature and ambient pressure are within a predefined range; and
the rotation speed gradient and injection volume gradient, or the resulting torque gradient, are less than a predefined limit value;
the operating mode of the internal combustion engine is an operating mode with active regeneration;
exhaust gas recirculation is deactivated.

According to an embodiment, the mathematical relationship can be configured in such a way that it evaluates a difference between two mathematical terms that each contain at least one of the partial measured variables.

The functional capability of the pitot mass flow sensor can furthermore be ascertained depending on whether the diagnostic value is outside a limit value range.

Alternatively, the diagnostic value can be averaged over a predefined minimum release time, and the functional capability of the pitot mass flow sensor can be ascertained depending on whether the averaged diagnostic value is outside a limit value range.

According to a further aspect, an apparatus is provided for checking a functional capability of a pitot mass flow sensor for measuring a mass flow of an inflowing gas in an engine system having an internal combustion engine, the apparatus being embodied to:
measure, as partial measured variables, a dynamic pressure that corresponds to a pitot pressure of a pitot tube of the pitot mass flow sensor, an absolute pressure, and a temperature of the inflowing gas;
determine a diagnostic value depending on the partial measured variables and on a mass flow in the internal combustion engine;
ascertain a functional capability of the pitot mass flow sensor depending on whether the diagnostic value indicates that a relationship between the partial measured variables corresponds to a predefined relationship.

According to a further aspect, an engine system having an internal combustion engine and the above apparatus is provided.

### BRIEF DESCRIPTION OF THE DRAWINGS

FIG. 1 schematically depicts an engine system that is equipped with a pitot mass flow sensor.

FIG. 2 is a flow chart to illustrate a method for checking a functional capability of the pitot mass flow sensor.

### DETAILED DESCRIPTION OF THE INVENTION

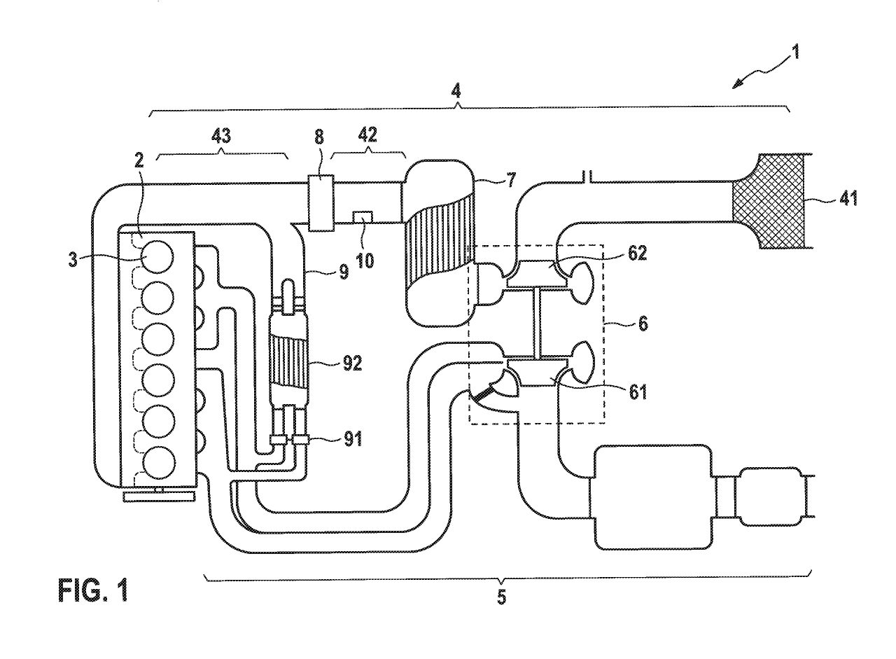

FIG. 1 schematically shows an engine system 1 having an internal combustion engine 2. Internal combustion engine 2 has cylinders 3 to which air is delivered via an air delivery system 4, and from which combustion exhaust gas is discharged through an exhaust gas discharge section 5.

A forced induction device 6, which has a turbine 61 in exhaust discharge section 5, is provided in order to convert exhaust gas enthalpy into mechanical energy and use it to drive a compressor 62. Compressor 62 is disposed in air delivery system 4 and serves to draw in fresh air from the environment via an air filter 41 and furnish it via a boost air cooler 5 in a boost pressure segment 42 of air delivery system 4. Boost pressure segment 42 is delimited downstream by a throttle valve 8. An intake duct segment 43 is provided between throttle valve 8 and the intake valves of cylinders 3 of internal combustion engine 2.

An exhaust gas recirculation conduit 9, which connects exhaust gas recirculation section 5 to intake duct segment 43 of air delivery system 4 in a region between the exhaust valves of internal combustion engine 2 and turbine 62 of the exhaust-gas-driven forced induction device 6, is provided. An exhaust gas recirculation valve 91, which is variably controllable in order to establish an exhaust gas mass flow in intake duct segment 43, is provided in exhaust gas recirculation conduit 9.

The above engine system 1 furthermore encompasses an engine control unit 15 that performs an application of control to internal combustion engine 2 depending on state variables sensed via sensors and with specification of a target torque, in particular by specifying control variables to actuators such as throttle valve 8 and exhaust gas recirculation valve 91, the opening and closing times of the intake and exhaust valves on cylinders 3, and the like.

The above-described configuration of an engine system having an internal combustion engine is merely exemplifying, and what is described below can also be used in engine systems having internal combustion engines without a forced induction device and/or without exhaust gas recirculation.

In conventional internal combustion engines, an air mass flow into internal combustion engine 2 is detected with the aid of a hot film air mass sensor between the inlet side of compressor 62 and air filter 41. If a pressure-based mass flow sensor, such as a pitot mass flow sensor 10, is used instead, this may be inserted, between boost air cooler 7 and throttle valve 8, as a pitot mass flow sensor 10.

A pitot mass flow sensor measures a pressure difference with the aid of a pitot principle. The pitot mass flow sensor has for this purpose a pitot tube that is oriented parallel to the flow, specifically so that a flow frontally strikes a tube opening. The flow velocity of a gas is determined by the pitot tube as a function of the dynamic pressure (which corresponds to a pitot pressure of the inflowing gas, i.e. the pressure exerted by the inflowing gas as a result of its velocity and mass) and an absolute pressure, i.e. an ambient pressure.

Pitot air mass flow sensor 10 therefore measures, as partial measured variables, a dynamic pressure Δp, an absolute pressure p_{abs}, and the temperature T of the mass flow flowing past, and determines the corresponding mass flow therefrom as follows:

$${\dot{m}}_{PFM} = \sqrt{2} \cdot {A}_{eff} \cdot \sqrt{\frac{{p}_{abs}}{{R}_{Gas}}} \cdot \sqrt{Δ p}$$

where A_{eff} corresponds to the effective cross-sectional area of the gas duct through which the gas flow to be measured is flowing, and R_{Gas} to a specific constant. The above equation can be derived from the continuity equation \dot{m}=ρ·A_{eff}·v, the transposed Bernoulli equation

$$v = \sqrt{\frac{2 \cdot Δ p}{ρ}} ,$$

and the calculated gas density

$$ρ = \frac{p}{R \cdot T} ,$$

where v corresponds to the flow velocity and ρ to the gas density.

According to regulatory provisions it is necessary to check the functional capability of the mass flow sensor that is used, and to plausibilize the sensed sensor values. This applies regardless of whether a hot film air mass sensor or a pitot mass flow sensor is involved.

When existing methods for checking the functional capability of the mass flow sensor are used, an intake duct pressure is measured with the aid of a separate intake duct pressure sensor provided therefor; and with the aid of the measured intake duct pressure and the engine speed, the air volume flowing into the engine is determined and is compared with the measured value from the air mass sensor. The functional capability of the mass flow sensor can thereby be checked.

In order to check the functional capability of a pitot mass flow sensor in boost pressure segment 42 with no need to utilize measured values of a pressure sensor in the intake duct segment or at another location in the air delivery system, or other state variables describing the state of gas flows, a plausibilization is now performed by comparing flow velocities or volumetric flows through air delivery system 4, based on the three partial measured variables furnished by pitot mass flow sensor 10, with exhaust gas recirculation valve 91 closed.

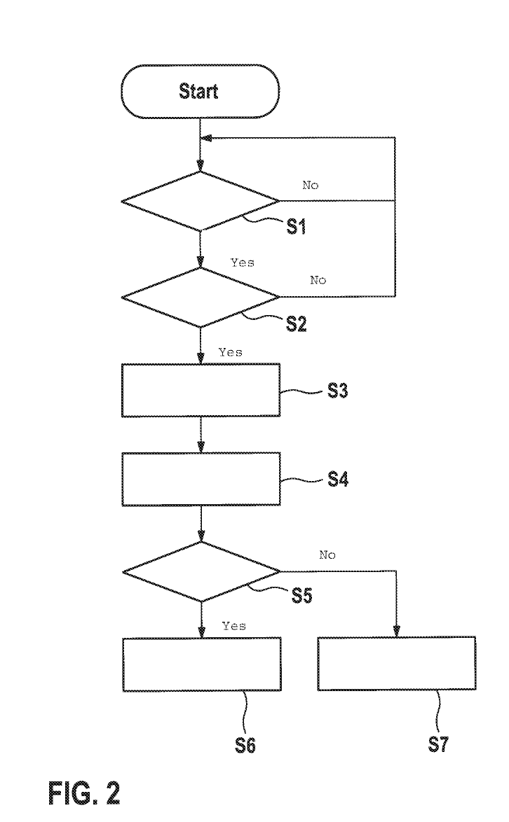

The functional capability is checked on the basis of a method that is depicted schematically in the flow chart of FIG. 2.

Step S1 checks whether release conditions for carrying out the diagnosis are met. If so (Yes branch), the method continues with step S2; otherwise (No branch) execution branches back to step S1.

The release conditions define an operating range in which the diagnosis can be permitted. These release conditions can encompass, in particular, one or more of the following criteria:
the rotation speed of the internal combustion engine is within a predefined rotation speed range;
the injection volume or torque of the internal combustion engine is within a predefined range;
the throttle valve is open, in particular completely open;
the ambient temperature and ambient pressure are within a predefined range;
the rotation speed gradient and injection volume gradient, or the resulting torque gradient, are less than a predefined limit value;
the operating mode of the internal combustion engine is an operating mode with active regeneration;
exhaust gas recirculation is deactivated.

Step S2 checks whether exhaust gas recirculation valve 91 is closed. The latter can have been actively closed in order to carry out the diagnosis, or can be in a closed state because of the operating state of the internal combustion engine. If the exhaust gas recirculation valve is closed (Yes branch), the method continues with step S3; otherwise (No branch) execution branches back to S1.

In step S3 a specific time delay is observed until the air system has stabilized. This applies in particular when exhaust gas recirculation valve 91 has been closed in order to carry out the method, and the resulting abrupt change in the mass flow of recirculated exhaust gas causes excitation of an oscillation in the aspirated air mass flow.

In step S4 a diagnostic value rDiag is calculated based on the measured variables of the dynamic pressure Δp, absolute pressure p_{abs}, and temperature T of the mass flow flowing past. The calculation is based on a comparison of the gas velocities at the location of pitot mass flow sensor 10 and the gas velocity at the intake manifold, i.e. in intake duct segment 43 immediately before entering internal combustion engine 2. The expression for the gas velocity at the location of the pitot mass flow sensor is:

$$v = \sqrt{\frac{2 \cdot Δ p \cdot R \cdot T}{{P}_{Abs}}} = \sqrt{\frac{2 \cdot Δ P}{ρ}}$$

and for the gas velocity in the intake manifold:

$$v = \frac{{\dot{V}}_{22 , Ref}}{{A}_{eff}} .$$

These gas velocities are equalized, with the following result:

$$\sqrt{\frac{2 \cdot Δ p \cdot R \cdot T}{{P}_{Abs}}} = \frac{{\dot{V}}_{22 , Ref}}{{A}_{eff}} .$$

The expression for the volumetric flow in internal combustion engine 2 is:

$${\dot{V}}_{22 , Ref} = {λ}_{a} \cdot \frac{nEng}{2} \cdot {V}_{Eng}$$

where nENG corresponds to the engine speed, V_{Eng} to the displacement of internal combustion engine 2, and λₐ to the air consumption of internal combustion engine 2.

Transposing for dynamic pressure Δp yields:

$$Δ p = \frac{p Abs}{T} \cdot \frac{1}{2 \cdot R} \cdot {( \frac{{\dot{V}}_{22 , Ref}}{{A}_{eff}} )}^{2} ,$$

and introducing the reference volumetric flow yields:

$$Δ p = \frac{p Abs}{T} \cdot \frac{1}{2 \cdot R} \cdot {( \frac{{λ}_{a} \cdot nEng \cdot {V}_{22 , Ref}}{2 \cdot {A}_{eff}} )}^{2} .$$

The form thereby obtained is suitable for diagnosis, since what results from the partial measured variables obtained via pitot mass flow sensor 10, namely the dynamic pressure Δp, absolute pressure p_{abs}, and temperature T of the gas mass flow flowing past, is a linear correlation and thus not a square-root correlation. Distortions in the event of deviations are thereby excluded.

In addition, plausibilization does not depend on a separate pressure sensor or separate pressure measurement, which can thus be omitted.

In addition, the further additional variable parameters that are required, such as the engine speed nENG and air consumption λa, can be furnished by engine control unit 15 as very exact values and can be plausibilized separately. The volume V_{Eng}, effective cross-sectional area A_{eff}, and gas constant R are exactly applicable parameters that do not change over the running time of internal combustion engine 2. A diagnostic value rDiag is defined, obtained from the ratio between the left and the right side of the equation:

$$rDiag = \frac{Δ p}{\frac{{P}_{Abs}}{T} \cdot \frac{1}{2 \cdot R} \cdot {( \frac{{λ}_{a} \cdot nEng \cdot {V}_{Eng}}{2 \cdot {A}_{eff}} )}^{2}} .$$

Deviations in the relationship among the three partial measured variables can thereby be detected. Deviations of the diagnostic value rDiag from a value of 1 can be attributed to sensor drift of one of the partial measured variables, a degradation in air consumption, a leaky exhaust gas recirculation valve 91, or a leak in the intake duct segment. The diagnostic value rDiag will usually cluster around 1 if pitot air mass flow sensor 10 is functionally capable.

In step S5 a check is made, in a limit value comparison, as to whether the plausibilization variable is outside predefined limits. If so (Yes branch), in step S6 a fault in pitot mass flow sensor 10 is detected and correspondingly signaled. Otherwise (No branch) a signal is given in step S7 that pitot mass flow sensor 10 is functionally capable.

Provision can be made that when the measurement of the dynamic pressure Δp in pitot mass flow sensor 10 is very inaccurate at low differential pressures, provision is made by way of an release condition that the diagnosis is performed only in the moderate or upper load range of internal combustion engine 2.

In order to rule out any double detection of faults by other diagnostic systems, it is advisable if the sensors for measuring the absolute pressure p_{abs} and temperature T (absolute pressure sensor and temperature sensor) in pitot mass flow sensor 10 have been diagnosed previously, before the actual above-described diagnosis of pitot mass flow sensor 10 is carried out. Plausibilization of the functional capability of the absolute pressure sensor and temperature sensor can be carried out, for example, at engine start against ambient conditions, i.e. against ambient pressure and ambient air temperature.

In order to make the diagnosis more robust, it is possible to release the diagnostic value rDiag over a minimum release time and to check the averaged diagnostic value in the limit value comparison of step S5.

Alternatively, pitot mass flow sensor 10 can transmit, instead of the dynamic pressure Δp, only a mass flow equivalent TRANS. This is multiplied, in engine control unit 15, by an effective cross-sectional area A_{eff} in order to obtain the mass flow. The equation is:

\dot{m}_{PFM}=A_{eff}·TRANS

the following being calculated in pitot mass flow sensor 10:

$$TRANS = K \cdot \sqrt{\frac{2 \cdot Δ p \cdot p Abs}{R \cdot T}} = K \cdot \sqrt{2 \cdot Δ p \cdot ρ} = K \cdot v \cdot ρ ,$$

where K corresponds to a predefined constant.

The transmitted term TRANS physically represents a gas velocity multiplied by the gas density, or a mass flow divided by the effective cross-sectional area A_{eff}.

Because the physical differential pressure Δp is not available in engine control unit 15, the characteristic feature rDiag is transposed as follows:

$$rDiag = \frac{{TRANS}^{2}}{{( \frac{{\dot{V}}_{22 , Ref}}{{A}_{eff}} )}^{2} \cdot ρ} = \frac{{K}^{2} \cdot 2 \cdot Δ p \cdot ρ}{{( \frac{{\dot{V}}_{22 , Ref}}{{A}_{eff}} )}^{2} \cdot {ρ}^{2}} .$$

Squaring is performed in order to re-establish the linear correlation among the partial measured variables Δp, p_{abs}, and T.

What is claimed is:

1. A method for checking a functional capability of a pitot mass flow sensor for measuring a mass flow of an inflowing gas in an engine system having an internal combustion engine, comprising:
measuring, as partial measured variables, a dynamic pressure corresponding to a pitot pressure of a pitot tube of the pitot mass flow sensor, an absolute pressure, and a temperature of the inflowing gas;
determining a diagnostic value depending on the partial measured variables and on a mass flow in the internal combustion engine; and
ascertaining a functional capability of the pitot mass flow sensor based on the diagnostic value.

2. The method as recited in claim 1, wherein the functional capability of the pitot mass flow sensor is ascertained based on whether the diagnostic value indicates that a mathematical relationship between the partial measured variables corresponds to a predefined relationship.

3. The method as recited in claim 2, wherein the diagnostic value is determined by one of (i) a comparison of the gas velocities in the internal combustion engine, or (ii) a comparison of volumetric flows in the internal combustion engine.

4. The method as recited in claim 2, wherein the diagnostic value is determined for the internal combustion engine with deactivated exhaust gas recirculation.

5. The method as recited in claim 2, wherein a satisfactory functional capability of the pitot mass flow sensor is ascertained if at least one of the following release conditions is met:
a rotation speed of the internal combustion engine is within a predefined rotation speed range;
one of an injection volume or torque of the internal combustion engine is within a predefined range;
a throttle valve is open;
ambient temperature and ambient pressure are within a predefined range;
one of (i) a rotation speed gradient and injection volume gradient are less than a predefined limit value, or (ii) a torque gradient is less than a predefined limit value;
an operating mode of the internal combustion engine is an operating mode with active regeneration; and
exhaust gas recirculation is deactivated.

6. The method as recited in claim 2, wherein the predefined mathematical relationship evaluates a difference between two mathematical terms which each contain at least one of the partial measured variables.

7. The method as recited in claim 6, wherein the functional capability of the pitot mass flow sensor is ascertained as being unsatisfactory depending on whether the diagnostic value is outside a predefined limit value range.

8. The method as recited in claim 6, wherein the diagnostic value is averaged over a predefined minimum release time, and the functional capability of the pitot mass flow sensor is ascertained as being unsatisfactory depending on whether the averaged diagnostic value is outside a predefined limit value range.

9. An apparatus for checking a functional capability of a pitot mass flow sensor for measuring a mass flow of an inflowing gas in an engine system having an internal combustion engine, the apparatus comprising:
a sensor system configured to measure, as partial measured variables, a dynamic pressure corresponding to a pitot pressure of a pitot tube of the pitot mass flow sensor, an absolute pressure of the inflowing gas, and a temperature of the inflowing gas; and
a control unit including a processor configured to:
(i) determine a diagnostic value depending on the partial measured variables and on a mass flow in the internal combustion engine; and
(ii) ascertain a functional capability of the pitot mass flow sensor depending on whether the diagnostic value indicates that a relationship between the partial measured variables corresponds to a predefined relationship.

10. A non-transitory, computer-readable data storage medium storing a computer program having program codes which, when executed on a computer, perform a method for checking a functional capability of a pitot mass flow sensor for measuring a mass flow of an inflowing gas in an engine system having an internal combustion engine, the method comprising:
measuring, as partial measured variables, a dynamic pressure corresponding to a pitot pressure of a pitot tube of the pitot mass flow sensor, an absolute pressure, and a temperature of the inflowing gas;
determining a diagnostic value depending on the partial measured variables and on a mass flow in the internal combustion engine; and
ascertaining a functional capability of the pitot mass flow sensor based on the diagnostic value.
